(19) United States
(12) Patent Application Publication
(10) Pub. No.: US 2025/0128409 A1
(43) Pub. Date: Apr. 24, 2025

(54) Robotic Systems and Methods Used to Update Training of a Neural Network Based upon Neural Network Outputs

(71) Applicant: ABB Schweiz AG, Baden (CH)

(72) Inventors: Yinwei Zhang, Raleigh, NC (US); Qilin Zhang, Chicago, IL (US); Biao Zhang, Apex, NC (US); Jorge Vidal-Ribas, Esplugues de Llobregat (ES)

(73) Assignee: ABB Schweiz AG, Baden (CH)

(21) Appl. No.: 18/570,165

(22) PCT Filed: Jun. 17, 2021
(86) PCT No.: PCT/US2021/037794

§ 371 Date: Dec. 14, 2023

(51) Int. Cl. B25J 9/16; G06T 7/00; G06T 7/73

(52) U.S. Cl. CPC B25J 9/163; G06T 7/0002; G06T 7/74; G06T 2207/20084

(57) ABSTRACT

A robotic system for use in installing final trim and assembly part includes an auto-labeling system that combines images of a primary component, such as a vehicle, with those of computer based model, where feature based object tracking methods are used to compare the two. In some forms a camera can be mounted to a moveable robot, while in other the camera can be fixed in position relative to the robot. An artificial marker can be used in some forms. Robot movement tracking can also be used. A runtime operation can utilize a deep learning network to augment feature-based object tracking to aid in initializing a pose of the vehicle as well as an aid in restoring tracking if lost.

### TECHNICAL FIELD

The present disclosure generally relates to training neural networks, and more particularly, but not exclusively, to incorporation of translation and error feedback into updating the training of a neural network.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous manner. Yet such continuous motions of the vehicle(s) can cause or create certain irregularities with respect to at least the movement and/or position of the vehicle(s), and/or the portions of the vehicle(s) that are involved in the FTA. Moreover, such motion can cause the vehicle to be subjected to movement irregularities, vibrations, and balancing issues during FTA, which can prevent, or be adverse to, the ability to accurately track a particular part, portion, or area of the vehicle directly involved in the FTA. Traditionally, three-dimensional model-based computer vision matching algorithms require subtle adjustment of initial values and frequently loses tracking due to challenges such as varying lighting conditions, parts color changes, and other interferences mentioned above. Accordingly, such variances and concerns regarding repeatability can often hinder the use of robot motion control in FTA operations.

Accordingly, although various robot control systems are available currently in the marketplace, further improvements are possible to provide a system and means to calibrate and tune the robot control system to accommodate such movement irregularities.

### SUMMARY

One embodiment of the present disclosure is a unique system to update the training of a neural network. Other embodiments include apparatuses, systems, devices, hardware, methods, and combinations for generating heatmaps based upon regression output using a modified classifier. Further embodiments, forms, features, aspects, benefits, and advantages of the present application shall become apparent from the description and figures provided herewith.

### BRIEF DESCRIPTION OF THE FIGURES

FIG. 1 illustrates a schematic representation of at least a portion of an exemplary robotic system according to an illustrated embodiment of the present application.

FIG. 2 illustrates a schematic representation of an exemplary robot station through which vehicles are moved through by an automated or automatic guided vehicle (AGC), and which includes a robot that is mounted to a robot base that is moveable along, or by, the track.

FIG. 3 illustrates sensor inputs that may be used to control movement of a robot.

FIG. 4 illustrates an assembly line with a moving assembly base and a moving robot base.

FIG. 5 illustrates a flow chart of one embodiment of a neural network capable of updated training based upon heatmap of neural network outputs.

FIG. 6 illustrates a flow chart of one embodiment of determining a heatmap of neural network outputs.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

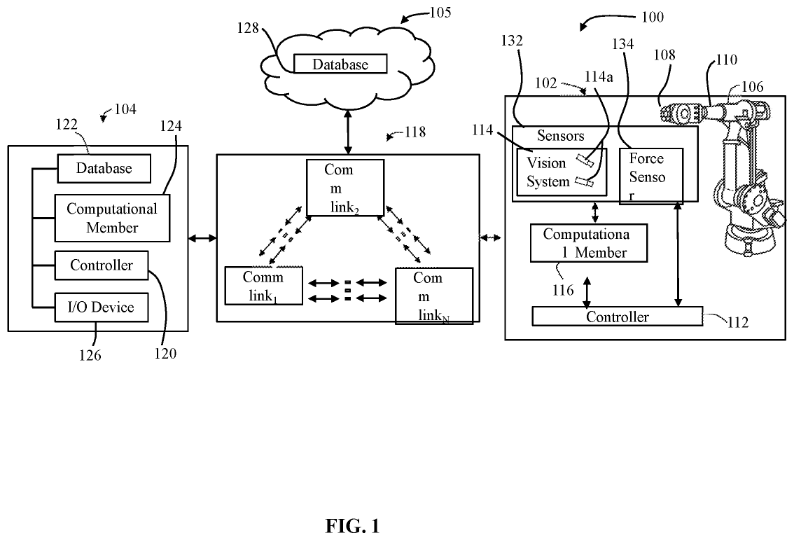

FIG. 1 illustrates at least a portion of an exemplary robotic system 100 that includes at least one robot station 102 that is communicatively coupled to at least one management system 104, such as, for example, via a communication network or link 118. The management system 104 can be local or remote relative to the robot station 102. Further, according to certain embodiments, the management system 104 can be cloud based. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the management system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations. For example, the end effector 108 of the robot can be used to manipulate a component part (e.g. a car door) of a primary component (e.g. a constituent part of the vehicle, or the vehicle itself as it is being assembled).

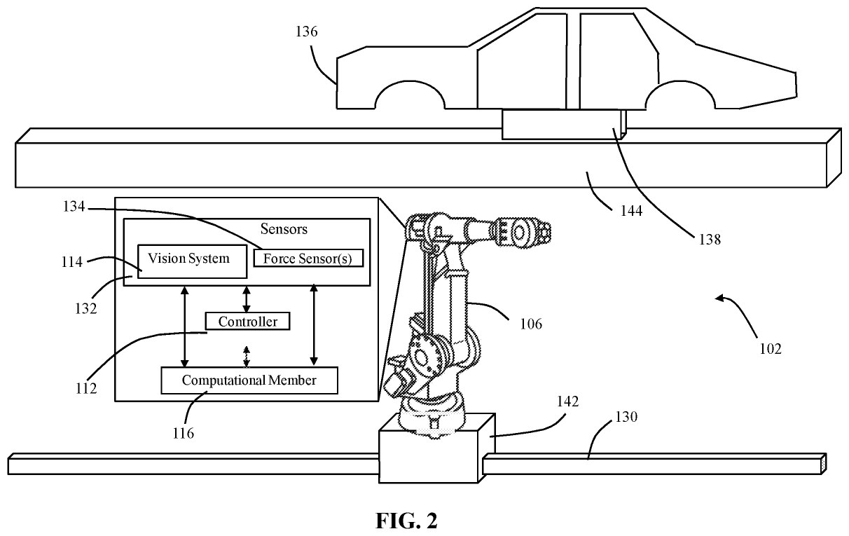

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively, by, a track 130 or mobile platform such as the AGV to which the robot 106 is mounted via a robot base 142, as shown in FIG. 2.

The controller 112 can take a variety of different forms, and can be configured to execute program instructions to perform tasks associated with operating the robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discrete devices and/or integrated circuits, which may be co-located at a particular location or distributed across more than one location, including any digital and/or analog devices configured to achieve the same or similar results as a processor-based controller executing software or firmware based instructions. Operations, instructions, and/or commands (collectively termed ‘instructions’ for ease of reference herein) determined and/or transmitted from the controller 112 can be based on one or more models stored in non-transient computer readable media in a controller 112, other computer, and/or memory that is accessible or in electrical communication with the controller 112. It will be appreciated that any of the aforementioned forms can be described as a ‘circuit’ useful to execute instructions, whether the circuit is an integrated circuit, software, firmware, etc. Such instructions are expressed in the ‘circuits’ to execute actions of which the controller 112 can take (e.g. sending commands, computing values, etc).

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

In some embodiments the robot station 102 and/or the robot 106 can also include one or more sensors 132. The sensors 132 can include a variety of different types of sensors and/or combinations of different types of sensors, including, but not limited to, a vision system 114, force sensors 134, motion sensors, acceleration sensors, and/or depth sensors, among other types of sensors. It will be appreciated that not all embodiments need include all sensors (e.g. some embodiments may not include motion, force, etc sensors). Further, information provided by at least some of these sensors 132 can be integrated, including, for example, via use of algorithms, such that operations and/or movement, among other tasks, by the robot 106 can at least be guided via sensor fusion. Thus, as shown by at least FIGS. 1 and 2, information provided by the one or more sensors 132, such as, for example, a vision system 114 and force sensors 134, among other sensors 132, can be processed by a controller 120 and/or a computational member 124 of a management system 104 such that the information provided by the different sensors 132 can be combined or integrated in a manner that can reduce the degree of uncertainty in the movement and/or performance of tasks by the robot 106.

According to the illustrated embodiment, the vision system 114 can comprise one or more vision devices 114a that can be used in connection with observing at least portions of the robot station 102, including, but not limited to, observing, parts, component, and/or vehicles, among other devices or components that can be positioned in, or are moving through or by at least a portion of, the robot station 102. For example, according to certain embodiments, the vision system 114 can extract information for a various types of visual features that are positioned or placed in the robot station 102, such, for example, on a vehicle and/or on automated guided vehicle (AGV) that is moving the vehicle through the robot station 102, among other locations, and use such information, among other information, to at least assist in guiding the movement of the robot 106, movement of the robot 106 along a track 130 or mobile platform such as the AGV (FIG. 2) in the robot station 102, and/or movement of an end effector 108. Further, according to certain embodiments, the vision system 114 can be configured to attain and/or provide information regarding at a position, location, and/or orientation of one or more calibration features that can be used to calibrate the sensors 132 of the robot 106.

According to certain embodiments, the vision system 114 can have data processing capabilities that can process data or information obtained from the vision devices 114a that can be communicated to the controller 112.

Alternatively, according to certain embodiments, the vision system 114 may not have data processing capabilities. Instead, according to certain embodiments, the vision system 114 can be electrically coupled to a computational member 116 of the robot station 102 that is adapted to process data or information output from the vision system 114. Additionally, according to certain embodiments, the vision system 114 can be operably coupled to a communication network or link 118, such that information outputted by the vision system 114 can be processed by a controller 120 and/or a computational member 124 of a management system 104, as discussed below.

Examples of vision devices 114a of the vision system 114 can include, but are not limited to, one or more imaging capturing devices, such as, for example, one or more two-dimensional, three-dimensional, and/or RGB cameras that can be mounted within the robot station 102, including, for example, mounted generally above or otherwise about the working area of the robot 106, mounted to the robot 106, and/or on the end effector 108 of the robot 106, among other locations. As should therefore be apparent, in some forms the cameras can be fixed in position relative to a moveable robot, but in other forms can be affixed to move with the robot. Some vision systems 114 may only include one vision device 114a. Further, according to certain embodiments, the vision system 114 can be a position based or image based vision system. Additionally, according to certain embodiments, the vision system 114 can utilize kinematic control or dynamic control.

According to the illustrated embodiment, in addition to the vision system 114, the sensors 132 also include one or more force sensors 134. The force sensors 134 can, for example, be configured to sense contact force(s) during the assembly process, such as, for example, a contact force between the robot 106, the end effector 108, and/or a component part being held by the robot 106 with the vehicle 136 and/or other component or structure within the robot station 102. Such information from the force sensor(s) 134 can be combined or integrated with information provided by the vision system 114 in some embodiments such that movement of the robot 106 during assembly of the vehicle 136 is guided at least in part by sensor fusion.

According to the exemplary embodiment depicted in FIG. 1, the management system 104 can include at least one controller 120, a database 122, the computational member 124, and/or one or more input/output (I/O) devices 126. According to certain embodiments, the management system 104 can be configured to provide an operator direct control of the robot 106, as well as to provide at least certain programming or other information to the robot station 102 and/or for the operation of the robot 106. Moreover, the management system 104 can be structured to receive commands or other input information from an operator of the robot station 102 or of the management system 104, including, for example, via commands generated via operation or selective engagement of/with an input/output device 126. Such commands via use of the input/output device 126 can include, but is not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the management system 104, received/transmitted from/to the supplemental database system(s) 105 and/or the robot station 102, and/or notifications generated while the robot 106 is running (or attempting to run) a program or process. For example, according to certain embodiments, the input/output device 126 can display images, whether actual or virtual, as obtained, for example, via use of at least the vision device 114a of the vision system 114. In some forms the management system 104 can permit autonomous operation of the robot 106 while also providing functional features to an operator such as shut down or pause commands, etc.

According to certain embodiments, the management system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the management system 104 can include a connecting device that may communicate with the communication network or link 118 and/or robot station 102 via an Ethernet WAN/LAN connection, among other types of connections. In certain other embodiments, the management system 104 can include a web server, or web portal, and can use the communication network or link 118 to communicate with the robot station 102 and/or the supplemental database system(s) 105 via the internet.

The management system 104 can be located at a variety of locations relative to the robot station 102. For example, the management system 104 can be in the same area as the robot station 102, the same room, a neighboring room, same building, same plant location, or, alternatively, at a remote location, relative to the robot station 102. Similarly, the supplemental database system(s) 105, if any, can also be located at a variety of locations relative to the robot station 102 and/or relative to the management system 104. Thus, the communication network or link 118 can be structured, at least in part, based on the physical distances, if any, between the locations of the robot station 102, management system 104, and/or supplemental database system(s) 105.

According to the illustrated embodiment, the communication network or link 118 comprises one or more communication links 118 (Comm link_{1-N} in FIG. 1). Additionally, system 100 can be operated to maintain a relatively reliable real-time communication link, via use of the communication network or link 118, between the robot station 102, management system 104, and/or supplemental database system(s) 105. Thus, according to certain embodiments, the system 100 can change parameters of the communication link 118, including, for example, the selection of the utilized communication links 118, based on the currently available data rate and/or transmission time of the communication links 118.

The communication network or link 118 can be structured in a variety of different manners. For example, the communication network or link 118 between the robot station 102, management system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the management system 104 and/or one or more databases 128 of the supplemental database system(s) 105 can include a variety of information that may be used in the identification of elements within the robot station 102 in which the robot 106 is operating. For example, as discussed below in more detail, one or more of the databases 122, 128 can include or store information that is used in the detection, interpretation, and/or deciphering of images or other information detected by a vision system 114, such as, for example, features used in connection with the calibration of the sensors 132, or features used in connection with tracking objects such as the component parts or other devices in the robot space (e.g. a marker as described below).

Additionally, or alternatively, such databases 122, 128 can include information pertaining to the one or more sensors 132, including, for example, information pertaining to forces, or a range of forces, that are to be expected to be detected by via use of the one or more force sensors 134 at one or more different locations in the robot station 102 and/or along the vehicle 136 at least as work is performed by the robot 106. Additionally, information in the databases 122, 128 can also include information used to at least initially calibrate the one or more sensors 132, including, for example, first calibration parameters associated with first calibration features and second calibration parameters that are associated with second calibration features.

The database 122 of the management system 104 and/or one or more databases 128 of the supplemental database system(s) 105 can also include information that can assist in discerning other features within the robot station 102. For example, images that are captured by the one or more vision devices 114a of the vision system 114 can be used in identifying, via use of information from the database 122, FTA components within the robot station 102, including FTA components that are within a picking bin, among other components, that may be used by the robot 106 in performing FTA.

FIG. 2 illustrates a schematic representation of an exemplary robot station 102 through which vehicles 136 are moved by an automated or automatic guided vehicle (AGV) 138, and which includes a robot 106 that is mounted to a robot base 142 that is moveable along, or by, a track 130 or mobile platform such as the AGV. While for at least purposes of illustration, the exemplary robot station 102 depicted in FIG. 2 is shown as having, or being in proximity to, a vehicle 136 and associated AGV 138, the robot station 102 can have a variety of other arrangements and elements, and can be used in a variety of other manufacturing, assembly, and/or automation processes. As depicted, the AGV may travel along a track 144, or may alternatively travel along the floor on wheels or may travel along an assembly route in other known ways. Further, while the depicted robot station 102 can be associated with an initial set-up of a robot 106, the station 102 can also be associated with use of the robot 106 in an assembly and/or production process.

Additionally, while the example depicted in FIG. 2 illustrates a single robot station 102, according to other embodiments, the robot station 102 can include a plurality of robot stations 102, each station 102 having one or more robots 106. The illustrated robot station 102 can also include, or be operated in connection with, one or more AGV 138, supply lines or conveyors, induction conveyors, and/or one or more sorter conveyors. According to the illustrated embodiment, the AGV 138 can be positioned and operated relative to the one or more robot stations 102 so as to transport, for example, vehicles 136 that can receive, or otherwise be assembled with or to include, one or more components of the vehicle(s) 136, including, for example, a door assembly, a cockpit assembly, and a seat assembly, among other types of assemblies and components. Similarly, according to the illustrated embodiment, the track 130 can be positioned and operated relative to the one or more robots 106 so as to facilitate assembly by the robot(s) 106 of components to the vehicle(s) 136 that is/are being moved via the AGV 138. Moreover, the track 130 or mobile platform such as the AGV, robot base 142, and/or robot can be operated such that the robot 106 is moved in a manner that at least generally follows of the movement of the AGV 138, and thus the movement of the vehicle(s) 136 that are on the AGV 138. Further, as previously mentioned, such movement of the robot 106 can also include movement that is guided, at least in part, by information provided by the one or more force sensor(s) 134.

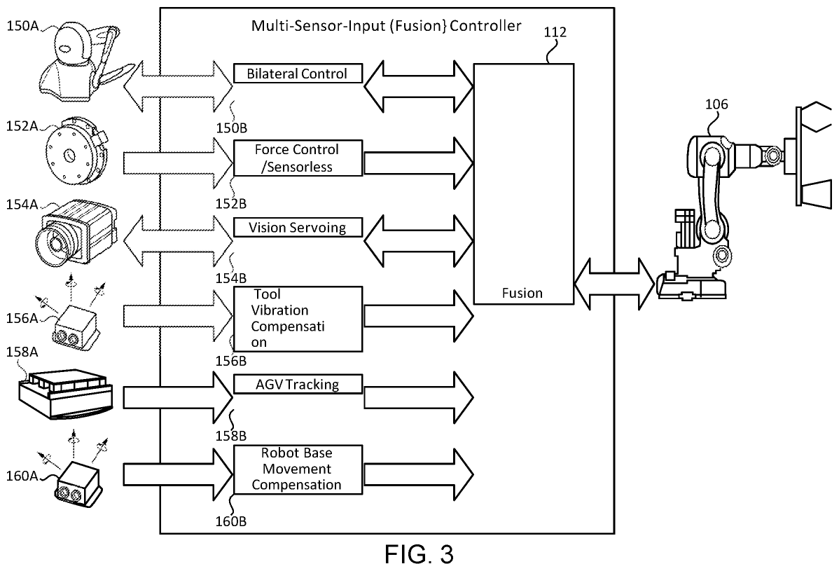

FIG. 3 is an illustration of sensor inputs 150-160 that may be provided to the robot controller 112 in order to control robot 106 movement. For example, the robotic assembly system may be provided with a bilateral control sensor 150A in communication with a bilateral controller 150B. A force sensor 152A (or 134) may also be provided in communication with a force controller 152B. A camera 154A (or 114A) may also be provided in communication with a vision controller 154B (or 114). A vibration sensor 156A may also be provided in communication with a vibration controller 156B. An AGV tracking sensor 158A may also be provided in communication with a tracking controller 158B. A robot base movement sensor 160A may also be provided in communication with a compensation controller 160B. Each of the individual sensor inputs 150-160 communicate with the robot controller 112 and may be fused together to control movement of the robot 106.

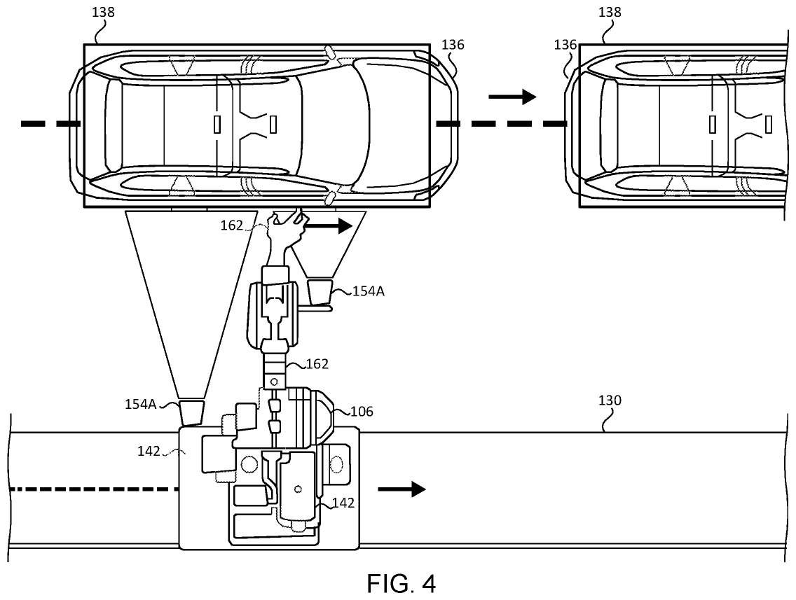

FIG. 4 is another illustration of an embodiment of a robot base 142 with a robot 106 mounted thereon. The robot base 142 may travel along a rail 130 or with wheels along the floor to move along the assembly line defined by the assembly base 138 (or AGV 138). The robot 106 has at least one movable arm 162 that may move relative to the robot base 142, although it is preferable for the robot 106 to have multiple movable arms 162 linked by joints to provide a high degree of movement flexibility.

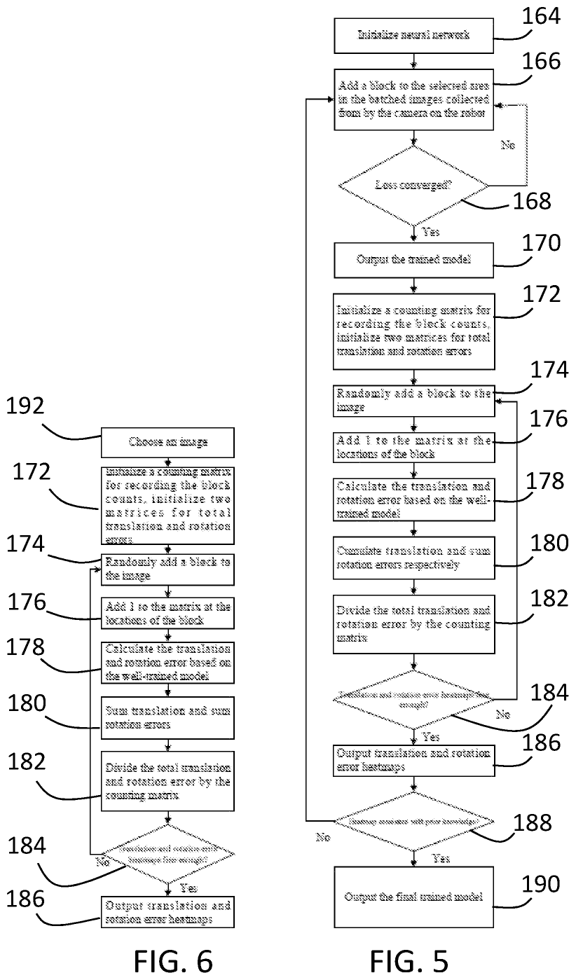

Turning now to FIG. 5, one embodiment of a system and method used to update training of a neural network for determining pose in the assembly of components with information from a heatmap. As will be appreciated, the procedure in FIG. 5 can be implemented in the controller 112. As will also be appreciated, the neural network referred to herein can be any variety of artificial intelligence including, but not limited to, deep learning neural networks. The procedure in FIG. 5 begins with an initialization of a neural network at 164 to ready the neural network for training with a set of training images. The training images represent two dimensional (2D) pictures of a component that is part of a manufacturing process, an example of which is described above. It will be appreciated, however, that the images can take any variety of forms as also described above. The images are paired with an associated pose which generally includes an identification of the primary component having a translation about three axes from a point of origin and a rotation about the three axes (which results in a six dimensional pose with three translations and three rotations).

The procedure at 166 includes adding a block to an area of the set of training images prior to training the neural network. The block can take any variety of forms but in general includes an occlusion such as a black or blurred feature in a defined area. The area can take on any shape such as square, rectangular, circular, oval, star, etc. which covers a subset of the image. In some forms the block can be an arbitrarily defined shape. Thus, as used herein block refers to any type of shape suitable for the purpose of altering a portion of the image. The procedure will include either dynamically defining attributes of the block (e.g. sizing and shaping of the block, including the coloring and/or blurriness, opaqueness, etc), or will include pulling from memory any predefined attributes of the block. Some embodiments may include dynamic definition of select attributes and predefined attributes that can be pulled from memory. The procedure in 166 includes not only expressing the attributes of the block but also placing the block on the set of training images. In some forms all training images will include the same block at the same location, but other variations are also contemplated.

Training of the neural network from 164 can be initiated after the block is added in 166. To ‘add’ a block includes the process by which such a block is the only block present in the image after it has been added, but in other forms to ‘add’ a block includes placing a block in addition to any other blocks that had been previously placed. In some embodiments which involve an initial pass of a first training of a neural network, the procedure in FIG. 5 can be configured to skip step 166 which includes adding the block. In either event, the neural network can be trained using a loss function which compares one or more training images (each with associated poses) against the estimated pose from the neural network. Any number of different loss functions can be used when training the neural network. The procedure in FIG. 5 determines in 168 if a loss from the loss function has converged by comparing the loss against a loss threshold. If the loss satisfies the loss threshold, then the procedure proceeds to 170 in which the neural network is considered ‘trained’ and is output for further use by the procedure in FIG. 5. If, however, the loss has not converged then the procedure returns to 166 to add a block to another location. Such return to 166 can include adding a block so as to replace the prior block passed in the first execution of 166 in many embodiments, or it can include adding the block while also keeping the prior existing block. In either case the neural network is again evaluated to determine if the loss from the loss function has converged.

Once the neural network is determined to have converged the procedure advances to 172 in which an image is chosen (e.g. from a set of testing images, but in some forms can be training or validation images) and eventually a heat map will be generated after several additional steps, where the heatmap will be based upon mappings of errors in the estimation of pose translation and pose rotation compared to the ground truth pose translation and pose rotation. Step 172 includes initializing a counting matrix for translation error and a counting matrix for rotation errors useful to record. The counting matrices include elements that correspond to pixels in the images in which blocks will be added in step 174. A random block (including random attributes and random location) is define at 174 and added to the image selected in 172. To ‘add’ a block includes the process by which such a block is the only block present in the image after it has been added, but in other forms to ‘add’ a block includes placing a block in addition to any other blocks that had been previously placed. In some forms the block is added in a methodical manner, such as placing the block in the upper right hand corner of an image, incrementally moving the block to the right across the span of the image, stepping the block down a row of pixels, and then incrementally moving the block to the left back across the span of the image. Such a methodical process can be repeated until all pixel rows are exhausted. Step 176 involves the procedure of adding the value of one to each element of the counting matrix that corresponds to a pixel in which the block has been added. The counting matrices will, therefore, include a section of 1's which is the same shape as the block that was added.

After the block has been added to the image the neural network is used to estimate the pose of the image (e.g. the pose of the component in the image) having the block added from 174, and from that step 178 can calculate the error between the known pose of the image to which the block was added against the prediction of the neural network of that pose in which the block was added. In the case of multiple images being assessed by having random blocks added to them, the translation and rotation errors induced in each of the respective images is summed together to form a total translation and a total rotation error at step 180. The total translation and total rotation errors are dividing by the counting matrix at step 182, and a heat map is developed based on it.

The heat map developed from the data in step 182 is evaluated against a resolution threshold in step 184. If the resolution meets the resolution threshold, then the procedure advances to step 186. Whether resolution meets a threshold (in other words, whether it is ‘sufficient’) can be assessed by whether the blocks cover (or have been covered) all the pixels in the image. In some embodiments, meeting the threshold can be determined by whether the pixels in the image are blocked at least once. If the heat map fails to achieve the resolution threshold then the procedure in FIG. 5 returns to step 174 to repeat the process of adding a random block to the selected image(s). when returning to step 174 the procedure in FIG. 5 of adding a block is accomplished so as to replace the prior block passed in the prior execution of 174 in many embodiments, or it can include adding the block while also keeping the prior block from the prior execution of 174. If the resolution threshold was satisfied then the error heatmap is output at 186 and compared against a baseline threshold (which can be prior knowledge developed offline), one form of which can be seen in FIG. 6 which is discussed further below. The comparison of the error heatmap with the prior knowledge (baseline threshold) is accomplished to see if the model suffers high error in rotation and translation when the pixels of the assembly part are blocked. A threshold can be set for the amount of translation error and/or rotation error. For example, in one form a translation error threshold of 2 mm can be set such that a heatmap having an error above 2 mm will not satisfy the comparison at 188. In another alternative and/or additional error check, a rotation error threshold of 1 degree can be set such that a heatmap having an error above 1 degree will not satisfy 188. Determination that the error heatmap satisfies the threshold aids in determining which portion or individual part in the component assembly is the most important one by checking the heatmap. If the error heatmaps output at 186 satisfy the baseline threshold at 188 then the neural network is output at 190 as the final trained model. If, however, the baseline threshold is not satisfied at 188, then the procedure in FIG. 5 returns to step 166 to retrain and/or update the training of the neural network using the procedures outlined above. The evaluation of whether the heatmap is consistent with prior knowledge can also be used to aid in data preprocessing (e.g. labeling) and data augmentation procedures.

The procedure outlined in FIG. 5 can include an interactive feature which includes training neural networks, deploying the neural networks to the field in a runtime operational environment, assessing the sensitivity of the runtime environment which may be different than the environment used in the collection of images for use in training the neural network. Such knowledge can lead to an understanding that the neural network is unwittingly emphasizing certain features which contribute to a reduction in robustness of the system. Furthermore, such knowledge gained in the field can assist in more quickly updating the training of the neural network to ignore certain features in order to make the system more robust. Steps 172-184 can be used in the field with test images to generate error heatmaps which aid in determining features to be blocked such as the block added in step 166. The field-based portions 172-184 can be automated and/or can be interactive with personnel whether or not in the field in the runtime environment.

FIG. 6 depicts an offline visualization technique to aid in understanding the sensitivity in the images of certain features. The procedure in FIG. 6 includes many of the same steps discussed in FIG. 5, and for that reason the description of FIG. 6 adopts the description from the corresponding steps above. To begin the procedure, FIG. 6 selects an image (from training, validation, or test images) at step 192, and then proceeds to evaluate the remainder steps in similar manner to those above.

An aspect of the present application includes a method to train a neural network using heat map derived feedback, the method comprising: initializing a neural network for a training procedure, the neural network structured to determine a pose of a manufacturing component in a testing image, each pose defined by a six dimensional pose which includes three rotations about separate axes and three translations along the separate axes; providing a set of training images to be used in training the neural network, each image in the set of training images including an associated pose; setting a block location in which an occlusion will reside in each image of the set of images when the neural network is trained; adding a block to the block location in the set of training images; and training the neural network using an error between a pose of a training image and the estimated pose of the training image provided by the neural network in light of the block added to each image in the set of training images.

A feature of the present application includes wherein the training the neural network includes converging a loss function based on the error.

Another feature of the present application further includes obtaining a test image and updating the training of the neural network through evaluation of a heat map of the test image.

Still another feature of the present application includes wherein the test image is separate from the set of training images, and which wherein the step of updating the training includes setting a test block location in which an occlusion will reside in the test image, adding a block to the test block location in the test image to form an occluded test image, and calculating a heat map of the occluded test image.

Yet another feature of the present application further includes evaluating the heat map against a resolution threshold, wherein if the heatmap fails to satisfy the resolution threshold then the step of setting a test block location is repeated with the test block at a new position.

Yet still another feature of the present application includes wherein the repeated step of setting a test block location is accomplished by randomly setting a test block location.

Still yet another feature of the present application includes wherein the repeated step of setting a test block location is accomplished by defining a block location based upon the heat map of the occluded test image.

A further feature of the present application includes, prior to the step of adding a block to the block location in the set of training images, evaluating a comparison of the heat map of the occluded test image to a prior determined heat map against a threshold and if the threshold is satisfied then proceeding to the step of adding a block.

A still further feature of the present application includes wherein the step of setting a test block location includes randomly setting the test block location, and which further includes evaluating the heat map against a resolution threshold, wherein if the heatmap fails to satisfy the resolution threshold then the step of setting a block location is repeated with a block at a new position.

A yet still further feature of the present application includes wherein after the step of adding a block to the test block location to form an occluded test image then initializing a translation counting matrix and a rotation counting matrix corresponding to the pixels in the occluded test image, adding the value of one to the locations of each of the counting matrices that correspond to pixels covered by the block used to form the occluded test image, calculating a translation and rotation error based on a comparison between the translation pose and rotation pose of the test image and a pose result of driving the trained neural network with the occluded test image, cumulating a total translation error and rotation error if the step of setting a block location is repeated, and dividing the translation and rotation error by the respective counting matrices.

Another aspect of the present application includes an apparatus to update a neural network based upon a heatmap evaluation of a test image, the apparatus comprising a collection of training images, each of image of the training images paired with an associated pose of a manufacturing component, each pose defined by a six dimensional pose which includes three rotations about separate axes and three translations along the separate axes; and a controller structured to train the neural network and configured to perform the following: initialize the neural network for a training procedure to be conducted with the collection of training images; receive a command to set a block location in which an occlusion will reside in each image of the collection of training images when the neural network is trained; add a block to the block location in the collection of training images; and train the neural network using an error between a pose of a training image and the estimated pose of the training image provided by the neural network in light of the block added to each image in the collection of training images.

A feature of the present application further includes a loss function to assess the error between the pose of the training image and the estimated pose of the training image, wherein the controller is further structured to receive a command to update a block location and add a block to the updated block location if a loss from the loss function has not converged.

Another feature of the present application includes wherein the controller is structured to restart training of a trained neural network based upon an evaluation of a heatmap of the test image, wherein the heatmap is determined after a heatmap step block location has been determined and a heatmap step block added at the heatmap step block location to the test image.

Still another feature of the present application includes wherein the operation to restart training includes re-initializing the neural network so that it is ready for training, wherein the test image is separate from the set of training images, and wherein the controller is structured to set the block location and add the block to the block location to form an occluded test image after the controller restarts training of the trained neural network.

Yet another feature of the present application includes wherein the controller is further structured to evaluate the heat map against a resolution threshold, wherein if the heatmap fails to satisfy the resolution threshold then the controller is structured to repeat the operation to determine a heatmap step block location and add the heatmap step block to the heatmap step block location.

Still yet another feature of the present application includes wherein when the controller is operated to repeat the determination of a heatmap step block location is accomplished by an operation to randomly set a heatmap step block location.

Yet still another feature of the present application includes wherein when the controller is operated to repeat the determination of a heatmap step block location is accomplished an operation define a block location based upon the heat map of the occluded test image.

A further feature of the present application includes wherein the controller is further structured such that prior to the operation to add a block to the block location in the set of training images the controller is operated to evaluate a comparison of the heat map of the occluded test image to a prior determined heat map against a threshold and if the threshold is satisfied then proceeding to the operation to add a block.

A yet further feature of the present application includes wherein the operation to set a test block location includes an operation to randomly set the test block location, and wherein the controller is further structured to evaluate the heat map against a resolution threshold, wherein if the heatmap fails to satisfy the resolution threshold then the operation to set a block location is repeated with a block at a new position.

A still yet further feature of the present application includes wherein after the operation to add a block to the test block location to form an occluded test image, the controller is structured to initialize a translation counting matrix and a rotation counting matrix corresponding to the pixels in the occluded test image, add the value of one to the locations of each of the counting matrices that correspond to pixels covered by the block used to form the occluded test image, calculate a translation and rotation error based on a comparison between the translation pose and rotation pose of the test image and a pose result of driving the trained neural network with the occluded test image, cumulate a total translation error and rotation error if the step of setting a block location is repeated, and divide the translation and rotation error by the respective counting matrices.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A method to train a neural network using heat map derived feedback, the method comprising:
initializing a neural network for a training procedure, the neural network structured to determine a pose of a manufacturing component in a testing image, each pose defined by a six dimensional pose which includes three rotations about separate axes and three translations along the separate axes;
providing a set of training images to be used in training the neural network, each image in the set of training images including an associated pose;
setting a block location in which an occlusion will reside in each image of the set of images when the neural network is trained;
adding a block to the block location in the set of training images; and
training the neural network using an error between a pose of a training image and the estimated pose of the training image provided by the neural network in light of the block added to each image in the set of training images.

2. The method of claim 1, wherein the training the neural network includes converging a loss function based on the error.

3. The method of claim 1, which further includes obtaining a test image and updating the training of the neural network through evaluation of a heat map of the test image.

4. The method of claim 3, wherein the test image is separate from the set of training images, and which wherein the step of updating the training includes setting a test block location in which an occlusion will reside in the test image, adding a block to the test block location in the test image to form an occluded test image, and calculating a heat map of the occluded test image.

5. The method of claim 4, which further includes evaluating the heat map against a resolution threshold, wherein if the heatmap fails to satisfy the resolution threshold then the step of setting a test block location is repeated with the test block at a new position.

6. The method of claim 5, wherein the repeated step of setting a test block location is accomplished by randomly setting a test block location.

7. The method of claim 5, wherein the repeated step of setting a test block location is accomplished by defining a block location based upon the heat map of the occluded test image.

8. The method of claim 4, which further includes, prior to the step of adding a block to the block location in the set of training images, evaluating a comparison of the heat map of the occluded test image to a prior determined heat map against a threshold and if the threshold is satisfied then proceeding to the step of adding a block.

9. The method of claim 4, wherein the step of setting a test block location includes randomly setting the test block location, and which further includes evaluating the heat map against a resolution threshold, wherein if the heatmap fails to satisfy the resolution threshold then the step of setting a block location is repeated with a block at a new position.

10. The method of claim 9, wherein after the step of adding a block to the test block location to form an occluded test image then initializing a translation counting matrix and a rotation counting matrix corresponding to the pixels in the occluded test image, adding the value of one to the locations of each of the counting matrices that correspond to pixels covered by the block used to form the occluded test image, calculating a translation and rotation error based on a comparison between the translation pose and rotation pose of the test image and a pose result of driving the trained neural network with the occluded test image, cumulating a total translation error and rotation error if the step of setting a block location is repeated, and dividing the translation and rotation error by the respective counting matrices.

11. An apparatus to update a neural network based upon a heatmap evaluation of a test image, the apparatus comprising:
a collection of training images, each of image of the training images paired with an associated pose of a manufacturing component, each pose defined by a six dimensional pose which includes three rotations about separate axes and three translations along the separate axes;
a controller structured to train the neural network and configured to perform the following:
initialize the neural network for a training procedure to be conducted with the collection of training images;
receive a command to set a block location in which an occlusion will reside in each image of the collection of training images when the neural network is trained;
add a block to the block location in the collection of training images; and
train the neural network using an error between a pose of a training image and the estimated pose of the training image provided by the neural network in light of the block added to each image in the collection of training images.

12. The apparatus of claim 11, which further includes a loss function to assess the error between the pose of the training image and the estimated pose of the training image, wherein the controller is further structured to receive a command to update a block location and add a block to the updated block location if a loss from the loss function has not converged.

13. The apparatus of claim 11, wherein the controller is structured to restart training of a trained neural network based upon an evaluation of a heatmap of the test image, wherein the heatmap is determined after a heatmap step block location has been determined and a heatmap step block added at the heatmap step block location to the test image.

14. The apparatus of claim 13, wherein the operation to restart training includes re-initializing the neural network so that it is ready for training, wherein the test image is separate from the set of training images, and wherein the controller is structured to set the block location and add the block to the block location to form an occluded test image after the controller restarts training of the trained neural network.

15. The apparatus of claim 14, wherein the controller is further structured to evaluate the heat map against a resolution threshold, wherein if the heatmap fails to satisfy the resolution threshold then the controller is structured to repeat the operation to determine a heatmap step block location and add the heatmap step block to the heatmap step block location.

16. The apparatus of claim 15, wherein when the controller is operated to repeat the determination of a heatmap step block location is accomplished by an operation to randomly set a heatmap step block location.

17. The apparatus of claim 15, wherein when the controller is operated to repeat the determination of a heatmap step block location is accomplished an operation define a block location based upon the heat map of the occluded test image.

18. The apparatus of claim 14, wherein the controller is further structured such that prior to the operation to add a block to the block location in the set of training images the controller is operated to evaluate a comparison of the heat map of the occluded test image to a prior determined heat map against a threshold and if the threshold is satisfied then proceeding to the operation to add a block.

19. The apparatus of claim 14, wherein the operation to set a test block location includes an operation to randomly set the test block location, and wherein the controller is further structured to evaluate the heat map against a resolution threshold, wherein if the heatmap fails to satisfy the resolution threshold then the operation to set a block location is repeated with a block at a new position.

20. The apparatus of claim 19, wherein after the operation to add a block to the test block location to form an occluded test image, the controller is structured to initialize a translation counting matrix and a rotation counting matrix corresponding to the pixels in the occluded test image, add the value of one to the locations of each of the counting matrices that correspond to pixels covered by the block used to form the occluded test image, calculate a translation and rotation error based on a comparison between the translation pose and rotation pose of the test image and a pose result of driving the trained neural network with the occluded test image, cumulate a total translation error and rotation error if the step of setting a block location is repeated, and divide the translation and rotation error by the respective counting matrices.
